(19) United States
(12) Patent Application Publication
(10) Pub. No.: US 2008/0170474 A1
(43) Pub. Date: Jul. 17, 2008

(54) TIMEPIECE FOR DISPLAYING INDICATIONS IN A WINDOW

(75) Inventors: Christophe Behling, London (GB); Gregoire Renoux, Neuchatel (CH)

Correspondence Address: PEARNE & GORDON LLP, 1801 EAST 9TH STREET, SUITE 1200, CLEVELAND, OH, 44114-3108, US

(73) Assignee: TAG HEUER SA, Chaux-de-Fonds (CH)

(21) Appl. No.: 12/033,499

(22) Filed: Feb. 19, 2008

Related U.S. Application Data
(63) Continuation of application No. PCT/EP2006/062669, filed on May 29, 2006.

(30) Foreign Application Priority Data
Sep. 13, 2005 (CH) 20051485

(51) Int. Cl. G04B 19/24

(52) U.S. Cl. 368/37

(57) ABSTRACT

Timepiece component (1) having a grande date display wherein the two discs are actuated independently from one another by stepping motors. The date's tens are displayed differently, for example in another color, in the morning and in the afternoon. It is also possible to combine the date indications with other independent indications.

### RELATED APPLICATIONS

The present application is a continuation of international application 2006WO-EP062669 (WO07031347) of May 29, 2006, the content of which is included by reference, and which claims priority of Swiss patent application 2005CH-1485 of Sep. 13, 2005, the contents whereof are included by reference.

### TECHNICAL FIELD

The present invention concerns the field of watch-making, in particular watches or watch components for displaying indications in a window.

### STATE OF THE ART

Watches and watch movements for displaying indications in the form of numeric symbols in a window are known per se. It is for example frequent to display the date, i.e. the day of the month, in the form of a digit in a window. Watches with several windows for displaying for example the tens of the dates in a first window and the units in another window also enjoy renewed popularity thanks to the readability of the indications made possible by the use of larger digits.

The indications displayed through the window are most often borne by a mobile, for example in the form of a disc, ring, cross, star, polygon etc. bearing different numeric indications. The mobile is driven by the movement that makes it advance by indexation step corresponding to the distance between the indications, so as to make the required indication appear through a window in the watch dial. Watch movements can also be conceived in which the mobiles are driven independently of the hands and of the other watch indicators by means of a stepping motor driving the hands.

WO2005006087 describes a watch provided with a chronograph comprising three windows for the mechanical and numeric display of the minutes and hours measured by the chronograph. Three indexed discs bearing digits turn behind the windows to supply the required indication. Another watch with three windows is described in WO2002093273. The use of three windows however requires a complex and delicate mechanism. Moreover, the windows take up considerable space on the dial.

Although the displaying of symbols in a window is appreciated and affords good readability, it is not possible to increase the number of windows in an unlimited manner without unacceptable aesthetic and space requirement constraints. Therefore, the number of indications displayed in the windows is limited; many indications, despite being useful, are not displayed for lack of space on the dial.

One aim of the present invention is thus to propose a timepiece free from these limitations, in particular a timepiece that makes better use of the windows and makes it possible to display more information without jeopardizing the readability of the display.

EP415734 describes a watch wherein a date or day of the week window allows additional graphical symbols to be displayed to indicate the morning or the afternoon. These additional symbols occupy additional indexation positions on the mobile. The size of the date or day of the week indications is thus reduced.

EP744675 describes a timepiece comprising a window allowing the battery level to be displayed next to a date or weekday indication. This instrument requires a movement capable of shifting the position of the mobile relative to fixed indexation positions. Again, in the case of a date display, the size of the numbers 1 to 31 must be reduced to leave space for the battery level indication.

CH190208 describes a timepiece having a dial allowing several mobiles for displaying the date, the month, the year and the day of the week, to be seen simultaneously. This construction requires several superimposed mobiles and considerable concessions as regards the size of the indications displayed in the window.

GB2017356 describes a device allowing the days of the week to be displayed in a first color in the morning and in another color in the afternoon.

WO2006/018157 describes a watch having a mobile for displaying one after the other the date, the moon phase or the end-of-life state of the battery. These indications are not displayed simultaneously.

### BRIEF DESCRIPTION OF THE INVENTION

These aims are achieved notably by means of a timepiece having the characteristics of claim 1.

This solution has the advantage of using the display space inside the windows better by displaying simultaneously several independent indications.

In a preferred embodiment, two indications independent from one another but both depending on absolute time are displayed simultaneously in a same window.

The space available on a window mobile is limited and it is not easily possible to inscribe therein with sufficient size all the combination possibilities of several sequences having each many possible indications. In a preferred embodiment, one of the sequences of indications is composed of several numeric or alphanumeric symbols whilst the other independent sequence has two values, for example {morning; afternoon}, {switched on; switched off}, or {operating mode 1; operating mode 2}.

In a preferred embodiment, a first indication, corresponding for example to a date or to a date digit, is displayed in the form of numeric symbol whilst another independent indication, representing for example the morning or the afternoon, is displayed by a choice of the color of the numeric symbol or of the background, or by other non numeric and/or non-alphanumeric symbols.

According to the invention, a second indication is added only to the indication of the tens of the date of a grande date display. The mobile of the date's tens must usually only display the possible values from 0 to 3 and it is thus possible to combine this relatively short sequence with another sequence, for example a binary sequence, without increasing in excessive fashion the number of combinations of indications the mobile has to display. Furthermore, the date's tens change only 4 times a month at most, so that few rotations are necessary for displaying all the possible combinations of indications.

The invention is also executed by means of a timepiece having a grande date display wherein the date's tens are displayed differently, for example in another color, in the morning and afternoon.

### BRIEF DESCRIPTION OF THE DRAWINGS

The invention will be better understood by reading an example of embodiment illustrated by the figures, wherein:

FIG. 1 shows a front view of a timepiece according to the invention;

FIG. 2 illustrates a first mobile, made in the form of a disc and allowing notably the tens of the date as well as another independent indication to be displayed;

FIG. 3 represents a second mobile, made in the form of a disc and allowing notably the tens of the date to be displayed.

### EXAMPLES OF EMBODIMENT(S) OF THE INVENTION

In the following description and claims, the expression “timepiece” designates for example a wristwatch, a movement for wristwatch, or another watch component for a watch to be worn on the body. The description refers in particular to a wristwatch.

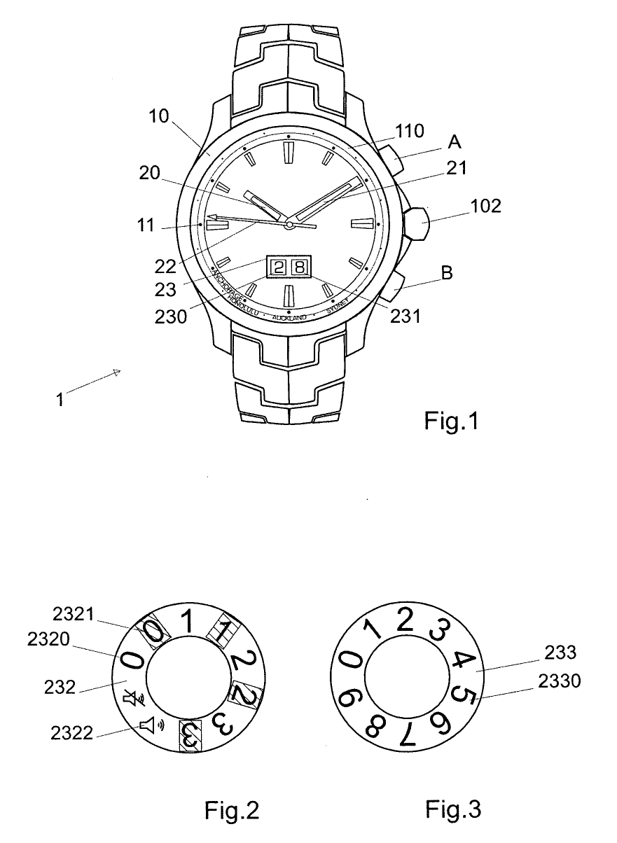

The timepiece 1, illustrated from the front in FIG. 1, has a case 10 accommodating a movement (not represented), preferably an electronic quartz movement, possibly a mechanical movement. The dial is provided with two windows 230, 231 for displaying notably the date (28 on the figure) with two distinct symbols, as well as other indications as will be seen. The time is displayed in a conventional manner by means of a hours' hand 20, a minutes' hand 21 and a seconds' hand 22. The three hands are placed at the center and actuated by an actuator (not represented), for example a stepping motor, or preferably by several independent stepping and preferably bidirectional motors. Other time indication means, including alphanumeric displays or displays allowing several time zones to be shown simultaneously can also be used within the frame of the invention. The invention can furthermore also be used with mechanical movements, the actuators being in this case constituted by elements of the gear train.

The timepiece illustrated in this example further has a groove (flange) 11 provided with 24 indications 110 of time zones, each time zone being signaled by a city name. The user can switch the time zone displayed by the hands 20, 21 and used for calculating the date and the morning/afternoon indication by moving, in a suitable mode, the seconds' hand towards the time zone selected by means of appropriate actions on the push-buttons A, B and on the time set and mode switch crown 102.

The crown 102 can occupy three distinct axial positions, for example a stable intermediary position C=0 (resting position), an instable pressed-in position C=−1 to enter into alarm mode or time zone mode, and a pulled-back position C=+1 for setting the date and the time. The crown preferably reverts of itself from the pressed-in position −1 to the intermediary position 0 when it is released. Two mono-stable push-buttons A and B are further provided.

FIG. 2 illustrates the mobile 232 of which one portion is visible through the first window 230. The mobile 233 of FIG. 3 is itself designed to be displayed through the second window 231. In this example, the two mobiles 232, 233 are constituted by rotating rings driven in rotation around their center by means of transmission chains (not represented). Other mobile forms, for example discs, can be used.

The two mobiles 232, 233 can be driven directly or indirectly by the stepping motor actuating notably the hours' hand. In a preferred embodiment, these mobiles are driven, independently of the hours' hand and preferably independently from one another, by means of actuators constituted by stepping motors independent of the motors actuating the hands and preferably bidirectional.

The first mobile 232 bears a sequence of indications 2320, 2321, 2322 on its surface. The indications 2320 and 2321 correspond in this example to tens of the date (day of the month) and can thus take the values 0 (that can also be represented by a space), 1, 2 or 3. According to the invention, each possible value of the tens of the date is inscribed twice, in two different manners, on the mobile 232. The first series of indications 2320 is used in this example in the morning whilst the second series of indications is used in the afternoon. Both types of indications 2320, 2321 are distinguished from one another in the illustrated example by the background color. It is for example possible to use a mocha color to illustrate the morning and a sunny yellow color for the afternoon. Other background color combinations can of course be used. It is also possible to distinguish the morning from the afternoon by the color of the numeric symbols or by the fonts used for the morning and the afternoon, or by graphic symbols or alphabetical indications (e.g. a.m./p.m.) placed next to or over the numeric symbol of the date. Thus, for most of the indexation positions of said mobile, an indication of the date's tens is displayed at the same time as the morning or afternoon indication in the same window. The disc of the date's tens is thus indexed twice a day: a noon in one direction and at midnight in the other direction, except when the date's tens change. Using a bidirectional stepping motor to drive this mobile makes it possible to reduce the rotation angle necessary at noon or at midnight, and thus to commute more rapidly the display in the window 230 whilst reducing the electric consumption.

The mobile 232 also bears for certain indexing positions icons 2322 illustrating an operating mode of the timepiece. In the illustrated example, two icons indicating an “alarm on” or “alarm off” mode are used. These icons can for example be displayed through the window 230 when the timepiece is in alarm time setting mode; activating or deactivating the alarm is then performed by means of a push-button A, B or of the crown, and immediately illustrated by a corresponding rotation of the mobile 232.

The second mobile 233 illustrated in FIG. 3 bears a single sequence of indications 2330 corresponding to the date's units. It is of course also possible to combine these indications with independent indications, for example indications depending on absolute time that can be represented by non numeric symbols.

The morning or afternoon indications borne by the mobile 232 can relate to the current time displayed by the hands 20-22, but also to another time, for example to the alarm setting time or to the time of another time zone temporarily displayed by the hands 20 to 22 or by other hands or indicators (not represented).

### REFERENCE NUMBERS

1 Timepiece
10 Case
11 Flange
110 Marking on the flange
A Push-button 1
B Push-button 2
102 Crown
20 Hours' hand
21 Minutes' hand
22 Seconds' hand
23 Grande date display
230 1^{st} window
231 2^{nd} window
232 Mobile of the date's tens
2320 Indications of the date's tens, in the morning
2321 Indications of the date's tens, in the afternoon
2322 Icons
233 Mobile of the date's units
2330 Indications of the date's units

1. Timepiece having:
a first window for displaying an indication of the date's tens from among a first sequence of indications borne by a first mobile on its surface,
a second window for displaying an indication of the date's unit from among a sequence of indications borne by a second mobile on its surface,
at least one actuator associated to the mobiles to make them turn in an indexed manner so as to make the indication chosen from among said sequence appear,
characterized in that, for at least one of the indexation positions of the first mobile, one additional indication independent from the date's tens is displayed simultaneously in the same window.

2. The timepiece of claim 1, wherein the indication of the date's tens is constituted by a numeric symbol and said additional indication is represented simultaneously in the form of the color of said symbol, of the background color, of a writing font of said symbol, of a graphic symbol or of any other non-alphanumeric marking.

3. The timepiece of claim 1, wherein one of said indications is displayed in non-numeric form to indicate the morning or the afternoon.

4. The timepiece of claim 3, wherein the morning is indicated by a first color and the afternoon is indicated by a second color.

5. The timepiece of claim 3, wherein said morning or afternoon indication refers to the current time indicated by the hands of the timepiece.

6. The timepiece of claim 3, wherein said morning or afternoon indication refers to an alarm setting time.

7. The timepiece of claim 3, wherein said morning or afternoon indication refers to the time of another time zone displayed by the timepiece.

8. The timepiece of claim 1, wherein at least one indexation position of said mobile makes it possible to display a single non-temporal indication connected to a mode of said timepiece.

9. The timepiece of claim 8, wherein said non-temporal indication corresponds to an alarm setting mode.

10. The timepiece of claim 1, wherein each of the mobiles is associated to an independent actuator.

11. The timepiece of claim 1, wherein the actuator or actuators are capable of imprinting to the mobile or mobiles a bidirectional rotation.
